(19) United States
(12) Patent Application Publication
(10) Pub. No.: US 2026/0161628 A1
(43) Pub. Date: Jun. 11, 2026

(54) FASTER CHANGE COMPUTATION USING BITSETS

(71) Applicant: Snowflake Inc., Bozeman, MT (US)

(72) Inventors: Yi Huang, Berlin (DE); Fabian Hüske, Berlin (DE); Valeri Kim, Sammamish, WA (US); Dzmitry Pauliukevich, Berlin (DE); Lukas Simon Probst, Berlin (DE); Eric Robinson, Sammamish, WA (US); Ankur Sharma, Berlin (DE); Lars Volker, Los Altos, CA (US)

(21) Appl. No.: 18/971,345

(22) Filed: Dec. 6, 2024

(51) Int. Cl. G06F 3/06

(52) U.S. Cl. CPC G06F 16/2282

(57) ABSTRACT

The subject technology identifies a change interval for a table. The subject technology determines a set of unregistered partitions and a set of registered partitions within the change interval. The subject technology identifies one or more partition lineage graphs (PLGs) connecting partitions in the set of unregistered partitions with partitions in the set of registered partitions. The subject technology determines a first set of changes from one or more PLGs. The subject technology determines a second set of changes from a set of remaining partitions in the set of unregistered partitions with partitions in the set of registered partitions. The subject technology consolidates the first set of changes determined from one or more PLGs and the second set of changes from the set of remaining partitions to generate a final set of changes for the table within the change interval.

### TECHNICAL FIELD

Embodiments of the disclosure relate generally to cloud data platforms and, more specifically, to implementations of Data Manipulation Language (DML) for SQL (Structured Query Language) used to manage and manipulate data within a database system(s), and the like.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

A data platform may store database data (e.g., a table) in multiple storage units, which may be referred to as partitions, micro-partitions, and/or by one or more other names. A database may be organized as records (e.g., rows or a collection of rows) that each include one or more attributes (e.g., columns). In an example, multiple storage units of a database can be stored in a block and multiple blocks can be grouped into a single file. That is, a database can be organized into a set of files where each file includes a set of blocks, where each block includes a set of more granular storage units such as partitions. It should be understood that the terms “row” and “column” are used for illustration purposes and these terms are interchangeable. For example, data arranged in a column of a table can similarly be arranged in a row of the table.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a data platform, in accordance with some embodiments of the present disclosure.

FIG. 2 is a block diagram illustrating components of a compute service manager of the cloud data platform, in accordance with some embodiments of the present disclosure

FIG. 3 illustrates an example of performing a delete operation with bitsets, in accordance with an embodiment of the subject technology.

FIG. 4 illustrates an example of a logical layout of a delta file, in accordance with an embodiment of the subject technology.

FIG. 5 illustrates an example of producing logical content of a delta file, in accordance with an embodiment of the subject technology.

FIG. 6 illustrates an example of producing a delta file, in accordance with an embodiment of the subject technology.

FIG. 7A illustrates a graph including a change interval and partition operations that were applied during the change interval, in accordance with an embodiment of the subject technology.

FIG. 7B illustrates a graph including another example of a change interval and partition operations that were applied during the change interval, in accordance with an embodiment of the subject technology.

FIG. 8 illustrates an example of an unregistered root partition and a registered combined partition, in accordance with an embodiment of the subject technology.

FIG. 9 illustrates an example of an unregistered combined partition and a registered combined partition, in accordance with an embodiment of the subject technology.

FIG. 10 illustrates an example with PLGs with pure changes, in accordance with an embodiment of the subject technology.

FIG. 11 is an example of PLGs with few redundant changes, in accordance with some embodiments of the present disclosure.

FIG. 12 is an example of change computation with a set of optimizations, in accordance with some embodiments of the present disclosure.

FIG. 13 is a flow diagram illustrating operations of a database system in performing a method, in accordance with some embodiments of the present disclosure.

FIG. 14 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The subject technology advantageously provides the following improvements: 1) enabling computing advanced metadata (e.g., number of distinct values, the like), thereby improving read operation performance; 2) integrating bitsets in micro-partition files, thereby enabling leveraging storage management and optimization features such as encryption and caching.

In the realm of data management, efficiently computing changes within databases presents a significant challenge. Existing approaches often involve processing substantial amounts of data to determine updates, deletions, or insertions. This process frequently leads to increased computational costs and inefficiencies due to the handling of unchanged data.

Existing solutions typically employ mechanisms that, while maintaining data integrity, result in the processing of redundant information. This redundancy arises from managing unchanged data alongside actual changes, thereby inflating the resources required. The need for a more streamlined approach that minimizes unnecessary processing is evident, especially in systems where large volumes of data undergo frequent modifications.

Embodiments of the subject technology provide a change computation mechanism to improve performance by reducing the number of input rows for change processing and consolidation. For example, the subject system identifies partitions from which changes can be extracted without producing redundant change rows, thus excluding them from unnecessary scans.

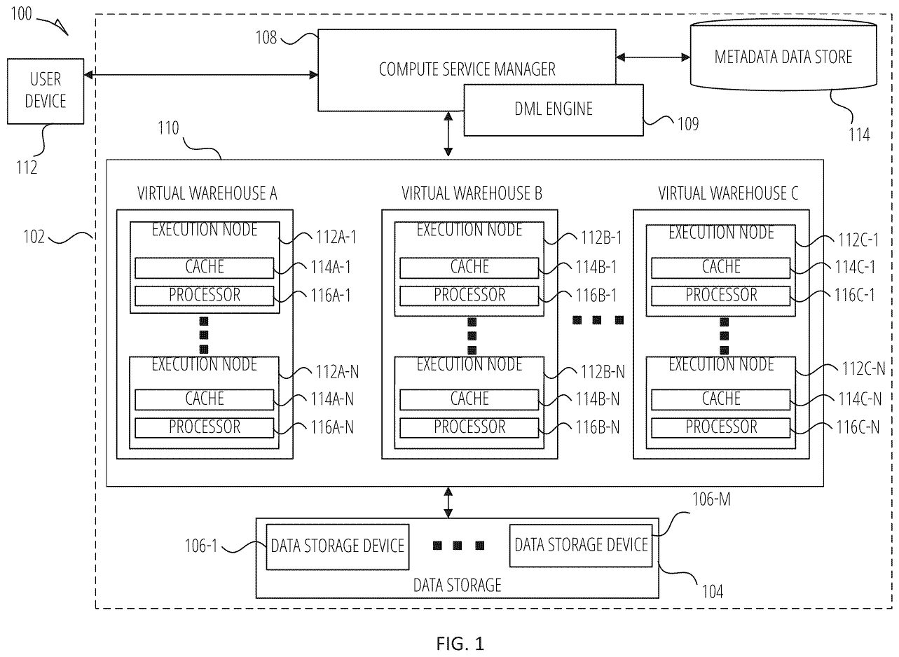

FIG. 1 illustrates an example computing environment 100 that includes a data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a three-tier architecture: a compute service manager 108 coupled to a metadata data store 114, an execution platform 110, and data storage 104. The data platform 102 hosts and provides data access, management, reporting, and analysis services to multiple client accounts. Administrative users can create and manage identities (e.g., users, roles, and groups) and use permissions to allow or deny access to the identities to resources and services. The data platform 102 is used for reporting and analysis of integrated data from one or more disparate sources including storage devices within the data storage 104. The data storage 104 comprises a plurality of computing machines and provides on-demand computer system resources such as data storage and computing power to the data platform 102.

The compute service manager 108 includes multiple services that coordinate and manage operations of the data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

As shown, the compute service manager 108 includes a DML engine 109 that is responsible for performing operations related to improving DML queries, including at least generating and maintaining delta files, bitsets, and related metadata, as discussed further herein. Further details of the operation of the DML engine 109 are discussed below.

The compute service manager 108 is also in communication with a user device 112. The user device 112 corresponds to a user of one of the multiple client accounts supported by the data platform 102. In some implementations, the compute service manager 108 does not receive any direct communications from the user device 112 and only receives communications concerning jobs from a queue within the data platform 102.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution node 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution node 112B-1 to 112B-N; execution node 112B-1 includes a cache 114B-1 and a processor 116B-1; and execution node 112B-N includes a cache 114B-N and a processor 116B-N. Additionally, virtual warehouse C includes execution node 112C-1 to 112C-N; execution node 112C-1 includes a cache 114C-1 and a processor 116C-1; and execution node 112C-N includes an execution node 112C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the data storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 114 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

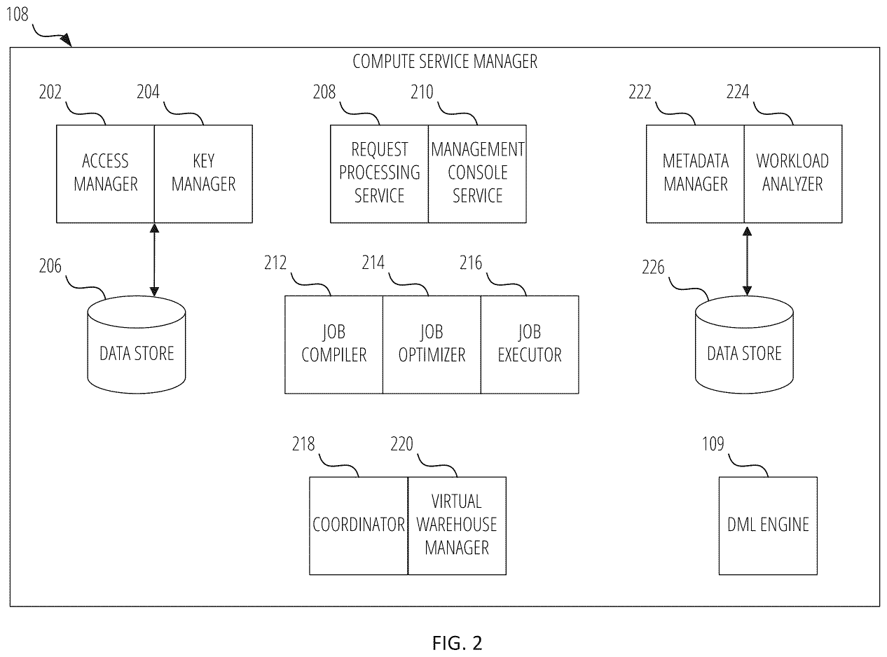

The compute service manager 108, metadata data store 114, execution platform 110, and data storage 104 are shown in FIG. 2 as individual discrete components. However, each of the compute service manager 108, metadata data store 114, execution platform 110, and data storage 104 may be implemented as a distributed system (e.g., distributed across multiple systems/platforms at multiple geographic locations). Additionally, each of the compute service manager 108, metadata data store 114, execution platform 110, and data storage 104 can be scaled up or down (independently of one another) depending on changes to the requests received and the changing needs of the data platform 102. Thus, in the described embodiments, the data platform 102 is dynamic and supports regular changes to meet the current data processing needs.

As mentioned further herein, terms “file” and “micro-partition” may each refer to a subset of database data and may be used interchangeably in some embodiments. The file metadata includes information about a micro-partition of the table. Further, metadata may be stored for each column of each micro-partition of the table. The metadata pertaining to a column of a micro-partition may be referred to as an expression property (EP) and may include any suitable information about the column, including for example, a minimum and maximum for the data stored in the column, a type of data stored in the column, a subject of the data stored in the column, versioning information for the data stored in the column, file statistics for all micro-partitions in the table, global cumulative expressions for columns of the table, and so forth. Each column of each micro-partition of the table may include one or more expression properties. It should be appreciated that the table may include any number of micro-partitions, and each micro-partition may include any number of columns. The micro-partitions may have the same or different columns and may have different types of columns storing different information. As discussed further herein, the subject technology provides a file system that includes “EP” files (expression property files), where each of the EP files stores a collection of expression properties about corresponding data. As described further herein, each EP file (or the EP files, collectively) can function similar to an indexing structure for micro-partition metadata. Stated another way, each EP file includes a “region” of micro-partitions, and the EP files are the basis for persistence, cache organization and organizing the multi-level structures of a given table's EP metadata. Additionally, in some implementations of the subject technology, a two-level data structure (also referred to as “2-level EP” or a “2-level EP file”) can at least store metadata corresponding to grouping expression properties and micro-partition statistics.

As mentioned above, a table of a database may include many rows and columns of data. One table may include millions of rows of data and may be very large and difficult to store or read. A very large table may be divided into multiple smaller files corresponding to micro-partitions. For example, one table may be divided into six distinct micro-partitions, and each of the six micro-partitions may include a portion of the data in the table. Dividing the table data into multiple micro-partitions helps to organize the data and to find where certain data is located within the table.

In an embodiment, the metadata data store 114 includes EP files (expression property files), where each of the EP files store a collection of expression properties about corresponding data. As mentioned before, EP files provide a similar function to an indexing structure into micro-partition metadata. Metadata may be stored for each column of each micro-partition of a given table.

In an example, a large source table may be (logically) organized as a set of regions in which each region can be further organized into a set of micro-partitions. Additionally, each micro-partition can be stored as a respective file in the subject system in an embodiment. Thus, the term “file” (or “data file”) as mentioned herein can refer to a micro-partition or object for storing data in a storage device or storage platform. In embodiments herein, each file includes data, which can be further compressed (e.g., using an appropriate data compression algorithm or technique) to reduce a respective size of such a file.

In some embodiments, metadata may be generated when changes are made to one or more source table(s) using a data manipulation language (DML), where such changes can be made by way of a DML statement. Examples of modifying data, using a given DML statement, may include updating, changing, merging, inserting, and deleting data into a source table(s), file(s), or micro-partition(s).

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the data platform 102. For example, data store 226 may represent caches in execution platform 110, storage devices in data storage 104, the metadata data store 114, or any other storage device or system.

In addition, as mentioned above, the compute service manager 108 includes a DML engine 109 that is responsible for performing operations related to improving DML queries, including at least generating and maintaining delta files, bitsets, and related metadata, as discussed further herein. Further details regarding the functionality of the DML engine 109 are discussed below.

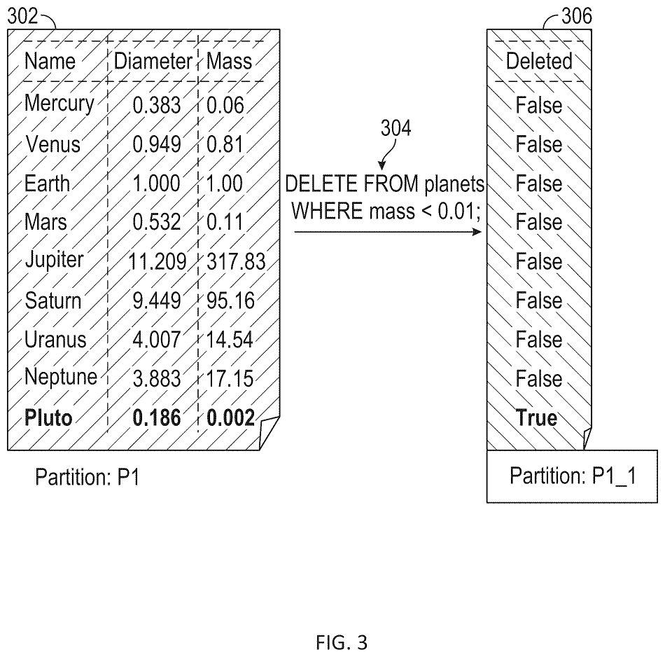

FIG. 3 illustrates an example of performing a delete operation with bitsets, in accordance with an embodiment of the subject technology. In an implementation, DML engine 109 can perform at least some of the operations discussed below.

In the example of FIG. 3, file 302 is processed in view of query 304, in which the result of this query is represented by bitset 306. As shown, partition P1_1 includes bitset 306. Partition P1 can be understood as a logical concept which includes a set of rows, while a file (e.g., file 302) is stored on a disk or in an object store. In an example, a given partition (e.g., partition P1) can include one or two files.

In an example, file 302 includes data for a table including values for name, diameter, and mass, each of which is a separate column in each row of the table.

The subject technology introduces delta files, which are created by DMLs that delete and/or update rows. A delta file is associated with exactly one data file referred to as its root file, and stores the difference to that root file. A root file can have exactly zero or one active delta file, and chains of delta files, therefore, are not created. Instead, subsequent updates will replace an existing delta file with a new one.

The subject technology advantageously provides the following improvements: 1) enabling computing advanced metadata (e.g., number of distinct values, the like), thereby improving read operation performance; 2) integrating bitsets in micro-partition files, thereby enabling leveraging storage management and optimization features such as encryption and caching.

The following discussion relates to a logical layout for a delta file.

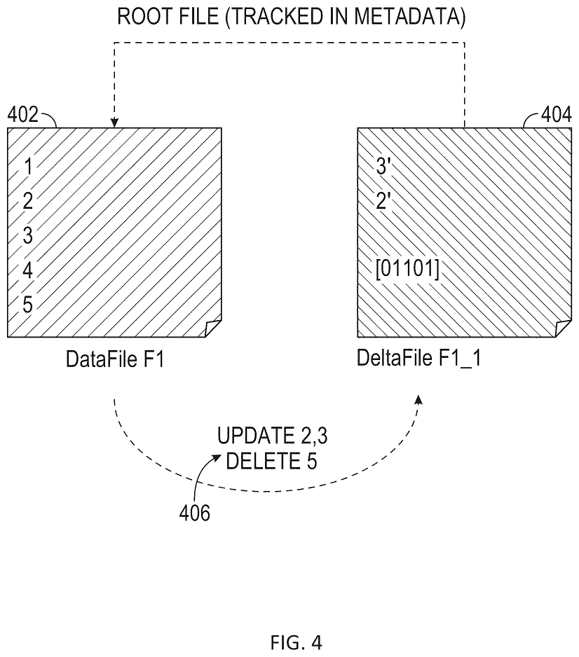

FIG. 4 illustrates an example of a logical layout of a delta file, in accordance with an embodiment of the subject technology. In an implementation, DML engine 109 can perform at least some of the operations discussed below.

In the example of FIG. 4, root file 402 and delta file 404 are illustrated where delta file 404 is associated with root file 402 based on a set of queries 406 that includes a first query with an update statement and a second query with a delete statement for performing on root file 402. The root file 402, in this example, includes a set of rows, each row having a value (e.g., as included in a column).

In an implementation, a delta file (e.g., delta file 404) stores:
1. A bitset set to mark rows of its root file as unregistered, i.e., deleted or updated.
2. Optionally a set of rows that are new versions of updated rows of its root file (e.g., this could be left out if no rows were updated such as in a DELETE statement). The order of the updated rows is not specified, i.e., their original order from the root file is not maintained.

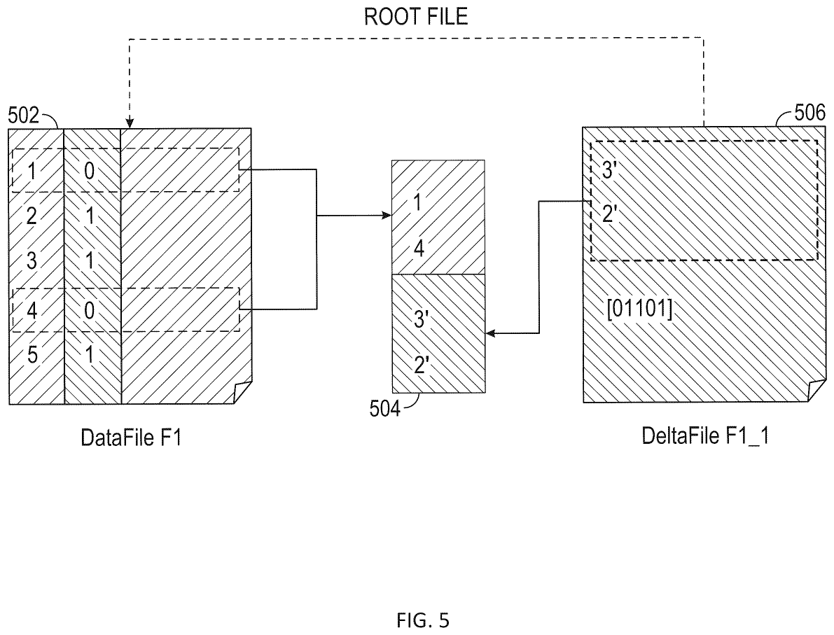

FIG. 5 illustrates an example of producing logical content of a delta file, in accordance with an embodiment of the subject technology. In an implementation, DML engine 109 can perform at least some of the operations discussed below.

In an implementation, the delta file-to-root file relationship is tracked in metadata (e.g., EP metadata and the like) and not in the delta file, at least because physical file names are not fixed (e.g., can change in view of performing rekeying, replication). In the example of FIG. 5, a root file of delta file 506 corresponds to data file 502.

Since the delta file stores the differences from its root file, the combined partition, which includes the delta file combined with the root file, includes the same data as a data file that was created using a copy-on-write mechanism. Copy-on-write (CoW) refers to a data processing technique such that when a database needs to modify data (e.g., as part of executing a given query), instead of modifying the existing data, CoW creates a new copy of the data (e.g., table, partition, file, and the like) with the modifications.

The logical content of a delta file, such as logical content 504, can be constructed by scanning its root file and filtering the rows using the delta file's bitset and scanning the delta file's updated rows.

In an example, a combined partition includes the rows that are obtained by applying the delta file on top of the root file, i.e. it can include one file (root file only) or two files (root+delta). As mentioned herein, a combined partition is one that includes the two files, and a regular partition (or simply “partition”) is one that is understood to only include one file (e.g., root file only).

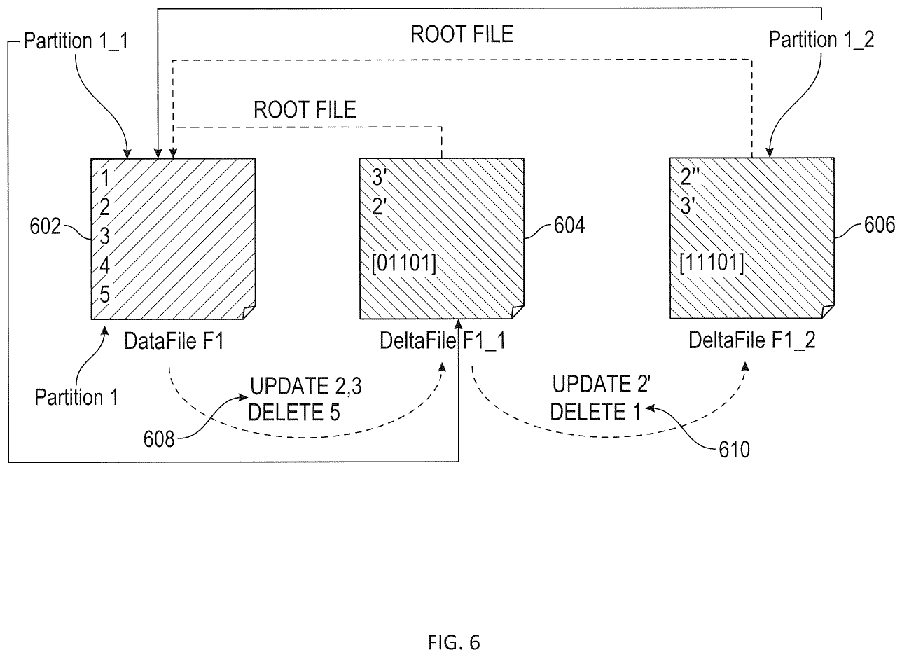

FIG. 6 illustrates an example of producing a delta file, in accordance with an embodiment of the subject technology. In an implementation, DML engine 109 can perform at least some of the operations discussed below.

In FIG. 6, query 608 is executed on data file 602 to generate delta file 604. Subsequently, delta file 606 is generated based on query 610 being processed on the partition including root file (e.g., data file 602) and delta file 604.

A delta file (e.g., delta file 606) can be produced when a DML statement(s) (e.g., query 610) deletes or updates rows that are (logically) contained in a delta file (e.g., delta file 604). The new delta file (e.g., delta file 606) will inherit the root file, the bitset, and all updated rows from the updated delta file and apply all additional changes of the current DML on top, i.e., it can mark additional rows in the bitset and store additional updated rows. Updated rows of the updated delta file that are not modified are copied forward into the new delta file, resulting in a CoW-like update behavior between two delta files. These delta files (e.g., delta file 604 and delta file 606) are referred to further herein as stacked delta files.

As illustrated, a first partition (e.g., partition 1) includes data file 602, a second partition (e.g., partition 1_1) includes data file 602 and delta file 604, and a third partition (e.g., partition 1_2) includes data file 602 and delta file 606.

Some existing approaches for computing changes in data tables are inefficient due to processing a large number of unchanged rows, increasing the cost of change processing and consolidation.

Embodiments of the subject technology provide techniques for improving change computation by leveraging partition lineage graphs and bitsets. The subject system improves performance by reducing the number of input rows for change processing and consolidation. For example, partitions are identified from which changes can be extracted without producing redundant change rows, thus excluding them from unnecessary scans.

More specifically, DML engine 109 utilizes partition lineage graphs to connect unregistered and registered partitions, allowing for efficient change extraction. This reduces redundant change rows and avoids unnecessary consolidation, thereby improving performance for streams-on-views and dynamic tables.

Some example advantages provided by the subject system include:
1) Partition Lineage Graphs (PLGs): The subject system uses PLGs to connect unregistered and registered partitions, allowing for efficient extraction of changes without redundancies. This approach helps in identifying partitions that can be excluded from change (pre-) consolidation.
2) Reduction of Redundant Rows: By identifying patterns in partition lineages, the subject system reduces the number of redundant change rows, minimizing unnecessary processing and consolidation.
3) Efficient Change Extraction: The method applies selective optimizations to extract changes more effectively, particularly for partitions with few redundant changes, thus improving performance.
4) Use of Bitsets: The subject system employs bitsets to track changes at the row level, which aids in efficiently identifying and processing changes, especially in the context of Copy-on-Write (CoW) mechanisms.

Overall, the subject system enhances the performance of change computation by significantly reducing the input rows and optimizing the extraction and consolidation processes.

The following discussion relates to change tracking metadata, which is discussed further herein.

When change tracking is enabled for a table, row-level change tracking metadata is collected during DML statement execution. This metadata is maintained in three hidden columns within the table's schema:
1. METADATA$ORIGINAL_PARTITION_NAME (MD$OPN)
2. METADATA$ORIGINAL_PARTITION_ROW_NUMBER (MD$OPRN)
3. METADATA$ROW_VERSION (MD$RV)

These hidden columns are persisted in FDN files alongside the table's actual data.

The first two columns (MD$OPN and MD$OPRN) are used to compute a unique row identifier, enabling row tracking across table versions and partitions:
MD$OPN stores the name of the file in which the row was initially inserted.
MD$OPRN stores the row's position within that partition.

When a new row is inserted into a table and written to a file, both MD$OPN and MD$OPRN are initially set to NULL. The first DML operation that copies a previously inserted row into a new partition sets these metadata columns to their correct values using the METADATA$PARTITION_NAME and METADATA$PARTITION_ROW_NUMBER pseudo columns. These values are propagated forward each time the row is copied (whether changed or unchanged) into a new partition due to various operations such as DMLs, reclustering, or small-file garbage collection.

The third metadata column, MD$RV, functions as a counter:
It is set to 0 when a row is newly inserted.
It is incremented by one each time the row is updated.

MD$RV serves two primary purposes:
1. To determine if a row was updated (when MD$OPN and MD$OPRN are equal but MD$RV differs)
2. To sort multiple versions of a row in their update order.

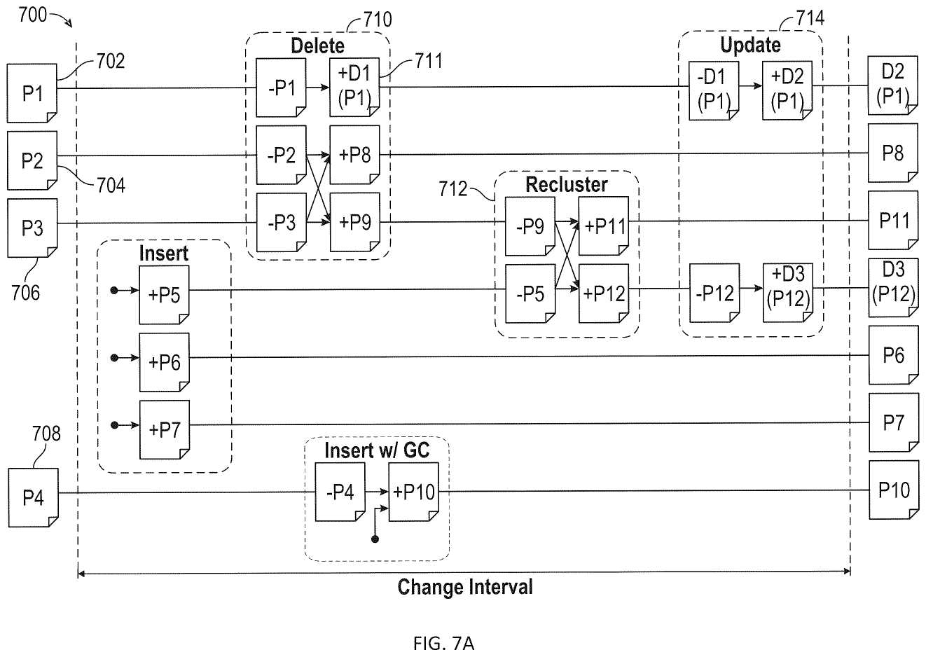

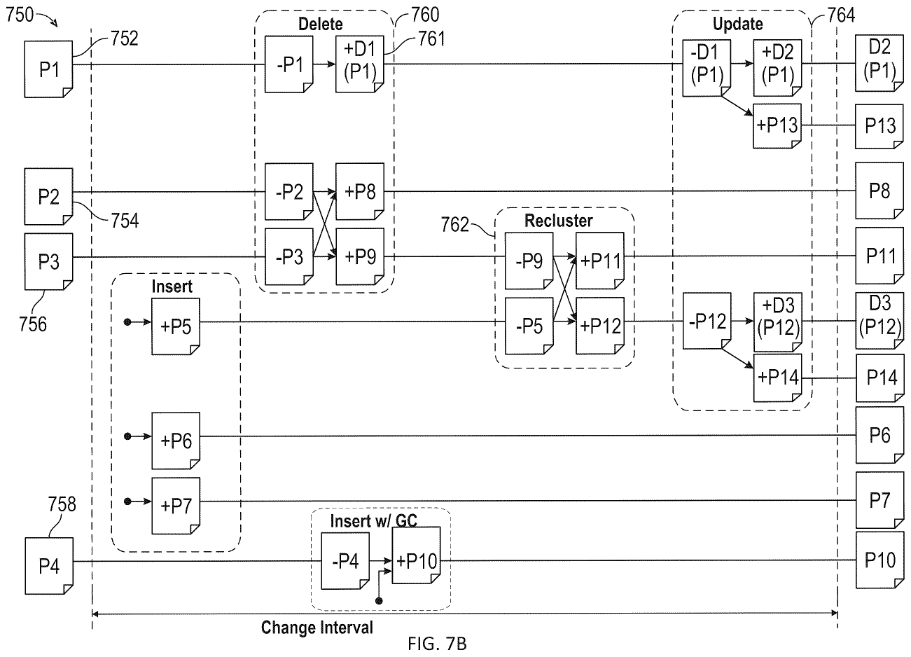

FIG. 7A illustrates a graph 700 including a change interval and partition operations that were applied during the change interval, in accordance with an embodiment of the subject technology.

In an example of FIG. 7A, faster changes computation is enabled by identifying partition lineage, which is a chain where a row is flowing from a leftmost partition, for example, to the rightmost partition. In graph 700, partition 702 (P1), partition 704 (P2), partition 706 (P3), and partition 708 (P4) are shown on the left-hand side. As also shown, several DMLs, a set of reclustering operations 712, and a set of update operations 714 are performed. On the right-hand side is the end state showing the lineage. The rows from P1 are fed into a delete operation from a set of delete operations 710 that creates D1, which is a delta file 711. D1 is then fed into an update statement from a set of update operations 714. The lines from P1 to the set of update operations 714 form a lineage graph where the rows will only flow within this line.

With respect to partition 704 P2, a copy and write is performed where the rows can get shuffled, and a direct correlation cannot be determined where the row(s) came from. The subject system identifies partition lineages and performs faster compute changes for these patterns in which certain patterns are identified that would help us compute changes faster without feeding in the copy and write rows into these.

Partition Lineage Graph (PLG) 1 links the unregistered partition P1 to the registered partition D2 (P1). This lineage is straightforward to identify due to the root file metadata present in combined partitions. Change extraction for this PLG is both efficient and straightforward, owing to the cumulative nature of delta files.

PLG 2 establishes connections between unregistered partitions P2 and P3, and registered partitions P8, P11, and D3 (P12). The identification of this lineage graph presents challenges due to its incorporation of multiple non-linear partition operations, specifically Copy-on-Write (CoW) DML and reclustering.

PLGs 3 and 4 each consist of a single registered partition (P6 and P7 respectively). These partitions are composed entirely of new rows, which can be determined by examining the null count of the MD$OPN column through their column EPs.

PLG 5 connects an unregistered partition 708 (P4) to the registered partition P10. Without supplementary metadata, this graph is challenging to identify. However, if partition lineage were tracked for small-file garbage collection (GC) during INSERT or MERGE operations, the identification of such graphs would become feasible.

The complexity of identifying and processing PLG 2 and 5 does not pose a significant issue, as it is not necessary to map every registered and unregistered partition to a PLG. Instead, the focus can be on identifying and isolating the easily recognizable PLGs, such as PLG 1, 3, and 4. The partitions associated with these readily identifiable PLGs can be removed from the sets of registered and unregistered partitions.

For the remaining registered and unregistered partitions that are not part of easily identifiable PLGs, the existing processing method can be maintained. This involves performing full scans of these partitions and subsequently consolidating their changes.

This approach allows for optimized processing of easily identifiable PLGs while maintaining a robust fallback method for more complex partition relationships. By selectively applying optimizations to identifiable patterns in partition lineages, this strategy can effectively reduce the number of copy-forwarded rows in change computation, potentially leading to improved performance.

A delta file lineage chain can be identified by searching for partitions with shared root partitions within the sets of unregistered and registered partitions. The identification process is straightforward due to the linear (1:1) nature of the root partition relationship and the fact that combined partitions store this information in their EP metadata.

In implementations where a set of updated rows are in a separate file (e.g. since the updated rows are written to a new root file without metadata pointing to the original root file), the aforementioned linear (1:1) nature of the root partition relationship does not apply.

Once identified, any pair of registered and unregistered partitions connected by a delta file link can be removed from their respective sets for separate processing.

The process of extracting changes from these delta-file-linked partition pairs can be approached in two ways, depending on how the linear delta file lineage chain intersects with the change interval.

This approach allows for more efficient change computation by leveraging the inherent relationships between partitions, potentially reducing the number of rows that need to be processed during change consolidation.

FIG. 7B illustrates a graph 750 including another example of a change interval and partition operations that were applied during the change interval, in accordance with an embodiment of the subject technology.

In an example of FIG. 7B, faster changes computation is enabled by identifying partition lineage, which is a chain where a row is flowing from a leftmost partition, for example, to the rightmost partition. In graph 750, partition 752 (P1), partition 754 (P2), partition 756 (P3), and partition 758 (P4) are shown on the left-hand side. As also shown, several DMLs, a set of reclustering operations 762, and a set of update operations 764 are performed. On the right-hand side is the end state showing the lineage. The rows from P1 are fed into a delete operation from a set of delete operations 760 that creates D1, which is a delta file 761. D1 is then fed into an update statement from a set of update operations 764. The lines from P1 to the set of update operations 764 form a lineage graph where the rows will only flow within this line.

In the example of FIG. 7B, the updated rows are in another partition shown in the set of update operations 764. For example, a set of updated rows is in P13, and another set of updated rows is in P14.

In an example, a set of rows in P13 and P14 can be included in the same file such that partition alignment may not be performed for the updated rows.

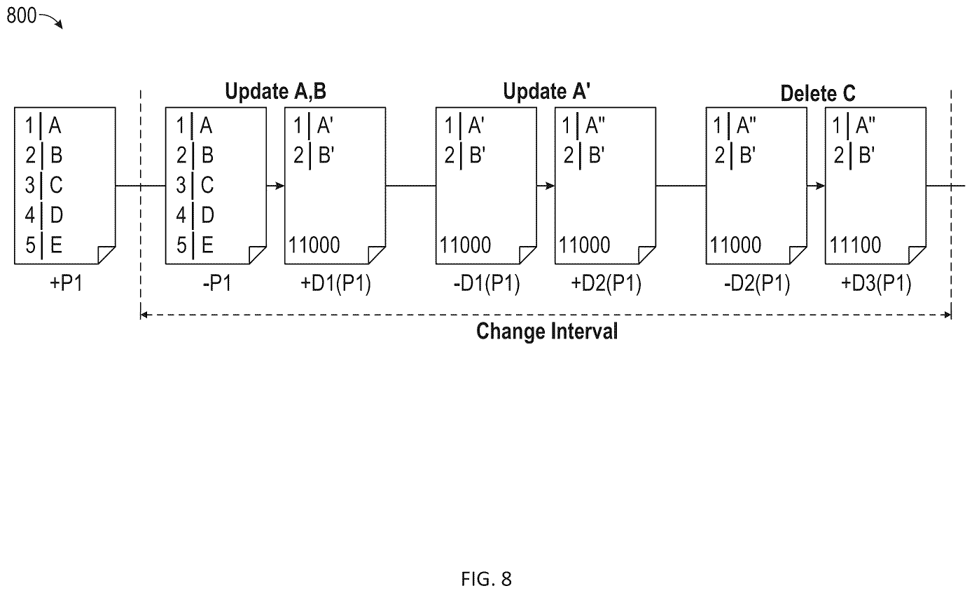

FIG. 8 illustrates an example 800 of an unregistered root partition and a registered combined partition, in accordance with an embodiment of the subject technology. The example of FIG. 8 relates to an example where updated rows are written to a delta file (e.g., not in a new file or partition).

The process of extracting changes from a delta file lineage chain can be simplified due to the cumulative nature of delta files. By focusing on the most recent delta file, the changes can be extracted as follows:
1. For deletions:
   Invert the bitset (e.g., 1,1,1,0,0 to 0,0,0,1,1).
   Read the root file using the new (inverted) bitset
   All rows marked as 0 are returned as DELETED
2. For insertions:
   Scan the final delta file. However, for implementations where updated rows are included in a new file (e.g., new partition), the updated rows would not be included in the final delta file.
   Emit all rows with MD$ACTION=INSERT

Using the provided example, this approach would yield the following results:
Deletions (MD$ACTION=DELETE): (1|A), (2|B), (3|C)·
Insertions (MD$ACTION=INSERT): (1|A″), (2|B′)

The above techniques leverage the cumulative property of delta files to efficiently compute changes without processing intermediate files, thereby reducing the computational overhead of change extraction.

The following provides additional discussion of an example scenario involving a partition P1 of FIG. 8. At the commencement of a change interval, denoted by a vertical line on the left side, a series of DML operations occur. These operations result in the creation of multiple partitions, including delta files. The sequence concludes at the terminus of the change interval.

In this scenario, the initial state is a root file. As the change interval progresses, various modifications occur, ultimately resulting in a final delta file. To compute the changes between the initial root file and the final delta file, one can leverage the properties of the delta file system.

Assuming a simplified case where only deletions occur (as opposed to updates), the final delta file would contain a deletion bitset marking specific rows as deleted. This bitset allows for efficient change computation without the need to examine intermediate files or perform complex comparisons.

By comparing the initial root partition with the final delta file's bitset, one can directly identify which rows were deleted during the change interval. Such an approach eliminates the necessity of processing intermediate files or performing intricate change calculations. The linear chain of delta files enables a straightforward determination that the rows marked as deleted in the final bitset represent the cumulative changes over the interval, regardless of any intermediate operations.

This approach significantly simplifies change computation, as it focuses solely on the initial and final states, disregarding intermediate modifications. The efficiency lies in the ability to extract change information directly from the bitset, without the need for comprehensive file reads or complex change consolidation processes.

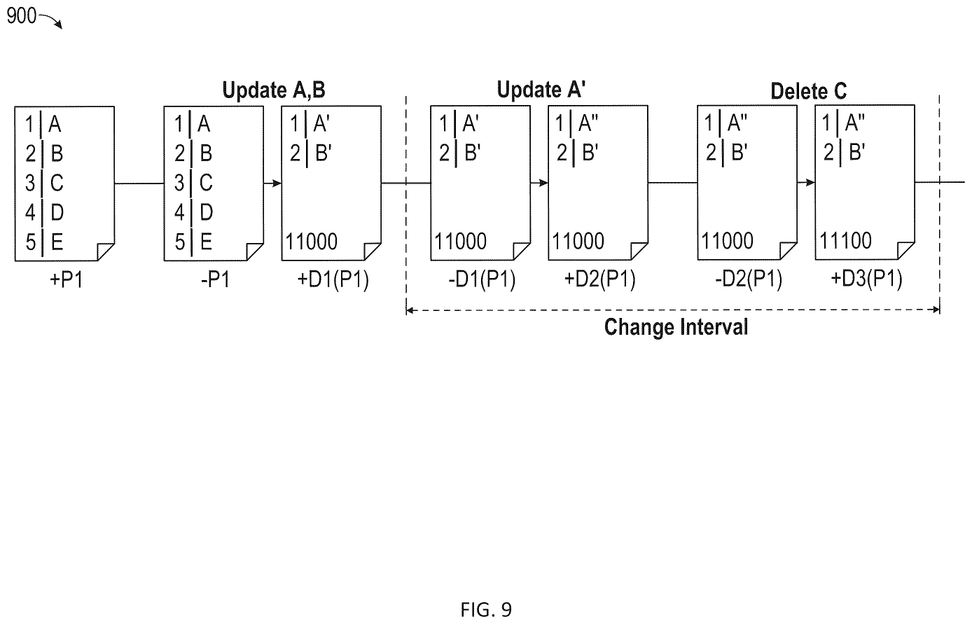

FIG. 9 illustrates an example 900 of an unregistered combined partition and a registered combined partition, in accordance with an embodiment of the subject technology. The example of FIG. 9 relates to an example where updated rows are written to a delta file (e.g., not in a new file or partition).

To extract changes when dealing with an unregistered combined partition and a registered combined partition, the process can be optimized by comparing only the initial and final delta files, without examining intermediate files. The change extraction procedure is as follows:
1. Scan the root file:
   Apply a filter using the XOR of the bitsets from the initial (D1) and final (D3) delta files
   Emit the remaining rows with MD$ACTION=DELETE
2. Scan the initial delta file (D1):
   Emit all rows with MD$ACTION=DELETE
3. Scan the final delta file (D3):
   Emit all rows with MD$ACTION=INSERT

Using the provided example, this method would yield:
Deletions (MD$ACTION=DELETE): (3|C), (1|A′), (2|B′)
Insertions (MD$ACTION=INSERT): (1|A″), (2|B′)

For steps 2 and 3 discussed above, in implementations where updated rows are provided in separate files, the new version of such updated rows would be in separate files.

Notably, this approach may introduce some redundancy, as evidenced by the deletion and insertion of (2|B′). This redundancy stems from the copy-on-write behavior of updated rows between delta files. This approach further leverages the cumulative nature of delta files to efficiently compute changes without processing intermediate files, potentially reducing the computational overhead of change extraction.

In the example of FIG. 9, a change interval that commences after the creation of an initial delta file is shown. As the interval progresses, multiple additional delta files are generated. To compute the changes in this scenario, an XOR operation can be performed on the bitsets of the initial and final states.

This XOR operation efficiently identifies which rows were modified during the interval. Subsequently, only these identified rows need to be read from the root file, eliminating the necessity to process any intermediate files. This approach exemplifies how partition lineage information can be leveraged to optimize change computation.

Additionally, the approach addresses partitions created by background services such as small file garbage collection and reclustering operations. By identifying and handling these partitions separately, the change computation process can be further optimized.

This approach significantly reduces the volume of data that needs to be processed during change computation, potentially improving performance and efficiency.

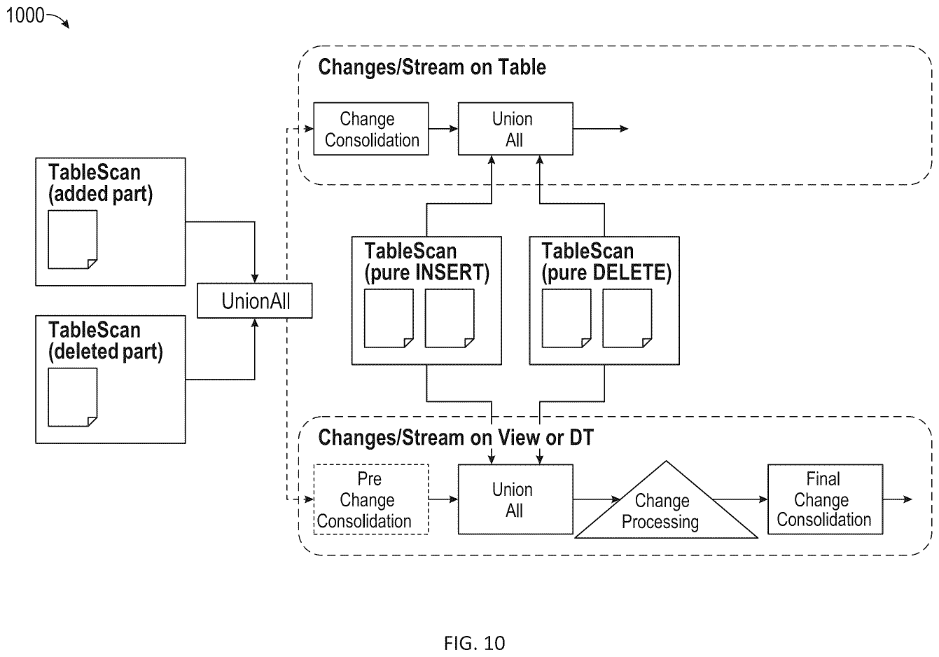

FIG. 10 illustrates an example 1000 with PLGs with pure changes, in accordance with an embodiment of the subject technology.

Partition Lineage Graphs (PLGs) that yield pure changes offer significant advantages in change computation. For streams and changes on tables, these pure changes can be directly returned without requiring consolidation.

In the context of streams and changes on views and Dynamic Tables (DTs), while the change processing step and final change consolidation step remain necessary, the change pre-consolidation step can be bypassed. This optimization is particularly beneficial due to the reduced input size, potentially leading to substantial efficiency gains in the overall change computation process.

The ability to skip the change pre-consolidation step for these PLGs with pure changes is a key feature of the faster change computation method. By reducing the volume of data that needs to be processed during the early stages of change computation, this approach can significantly improve performance, especially for large datasets or complex change intervals.

The following discussion relates to all-new partitions.

Partitions within the set of registered partitions that exclusively contain new rows and lack copy-on-write rows (resulting from small-file garbage collection) can be readily identified as individual Partition Lineage Graphs (PLGs). This identification process involves examining the column Extended Properties (EPs) of their Change Tracking (CT) metadata columns.

The key indicator for these partitions is that the null count of the METADATA$ORIGINAL_PARTITION_NAME (MD$OPN) column (and METADATA$ORIGINAL_PARTITION_ROW_NUMBER (MD$OPRN) column) must equal the total number of rows in the partition. This equality signifies that all rows in the partition are newly inserted.

Given that all rows in these files are newly inserted, they lack any connection to other partitions. Consequently, these partitions contain “pure” insert changes, which can bypass the change consolidation process entirely. This optimization significantly enhances the efficiency of change computation.

These all-new row partitions are typically generated by several mechanisms:
1. Streaming
2. COPY operations
3. INSERT Data Manipulation Language (DML) statements that introduce a substantial number of new rows

By identifying and processing these partitions separately, the change computation process can avoid unnecessary consolidation steps, potentially leading to improved performance, especially when dealing with large-scale data insertions.

To identify partitions containing only new rows, one can examine the change tracking metadata columns. If all these columns contain NULL values for every row in the partition, it indicates that all rows within that partition are newly inserted. This characteristic allows for a distinct treatment of such partitions during change computation.

Partitions identified as containing only new rows can be processed more efficiently, as they don't require the same consolidation steps as partitions with mixed or modified data. This optimization is particularly beneficial for operations that introduce large volumes of new data, such as those performed by streaming, COPY commands, or large-scale INSERT DML statements.

By leveraging this metadata-based identification method, the change computation process can bypass unnecessary consolidation steps for these “pure insert” partitions, potentially leading to significant performance improvements in change tracking and computation.

The following relates to fully deleted partitions.

Partitions within the set of unregistered partitions that were fully deleted without any of their rows being copied forward into a new partition can be processed in a manner similar to fully inserted partitions. Upon identifying a fully deleted partition within the set of unregistered partitions, it can be removed from the set and managed separately. This approach is analogous to the treatment of fully inserted partitions, with the key difference being that the rows are treated as deleted rather than inserted.

To facilitate the detection of such fully deleted partitions, additional metadata needs to be attached to the file unregistration record in delta EP files. Partitions can be unregistered through two mechanisms:
1. From Global Services (GS) (e.g., compute service manager 108): In this case, column EPs are used to determine if all rows meet the deletion predicate.
2. Via ScanBack: This occurs when the deletion predicate cannot be evaluated against column EPs.

Regardless of the unregistration method, the information indicating that a partition was fully deleted can be transmitted via the file unregistration request and subsequently recorded in the delta EP file. This additional metadata enables efficient identification and separate processing of fully deleted partitions during change computation, potentially improving the overall performance of the process.

Partitions within the set of unregistered partitions that have been fully deleted without any rows being copied forward can be managed efficiently through metadata-based identification. When a partition is fully deleted from Global Services (GS), it is not needed to process the file through the execution platform to delete individual rows, as the deletion information is available at the metadata level.

To optimize this process, a flag can be added to the EP file to mark these fully deleted partitions. This flag allows the system to identify and manage these partitions separately during change computation.

By leveraging this metadata flag, fully deleted partitions can be excluded from the standard change computation process. Instead, they can be processed separately and more efficiently, similar to how all-new partitions are managed. This approach eliminates the need to feed these partitions into the general change computation pipeline, potentially reducing the overall computational overhead.

The following discussion relates to small-file GC partitions.

Small-File Garbage Collection (SFGC) is a process applied during INSERT statements and on the INSERT-path of MERGE statements. During SFGC, small partitions are unregistered, and their rows are re-inserted (Copy-on-Write or CoW′d) into new partitions along with newly inserted rows. As a result, these new partitions contain a mix of newly inserted rows and CoW′d rows from the unregistered partitions.

To optimize change computation for SFGC operations, instead of scanning all unregistered and registered partitions and performing a diff to remove CoW′d rows, we can simply scan the registered partitions and filter on MD$OPN=NULL. This approach yields “pure” changes, as it only emits newly inserted rows and excludes copied rows.

However, this optimization method is only effective if all partitions involved in the SFGC process were effectively unregistered and registered within the change interval, with no other operations registering or unregistering them during this period. When this condition is met, we can remove the unregistered and registered partitions from the sets of partitions scanned for REDUNDANT_DELTA and scan the registered partitions separately. These partitions can be added to the set of all-new partitions by applying the MD$OPN=NULL predicate. To facilitate the identification of partitions involved in SFGC, we could introduce a flag in the registration/unregistration requests and track it in EP files.

The requirement that no preceding or succeeding operations interfere with the SFGC process may limit the applicability of this optimization. To broaden its applicability, more extensive lineage checks could be implemented. One potential approach is to consider only registered partitions that contain copied rows (where MD$OPN null-count<row-count). All other partitions would be managed by the all-new-rows optimization.

This optimization strategy can be extended to other background operations such as reclustering. By adding flags to partitions created, registered, or unregistered by these background services, we can handle them separately from the main change computation process. Instead of processing all rows through a single plan and change consolidation algorithm, it is possible to identify these patterns and direct them through different processing paths. The results from these separate paths can then be unioned (e.g., UNION operation) to produce the final result, effectively reducing redundant change computations.

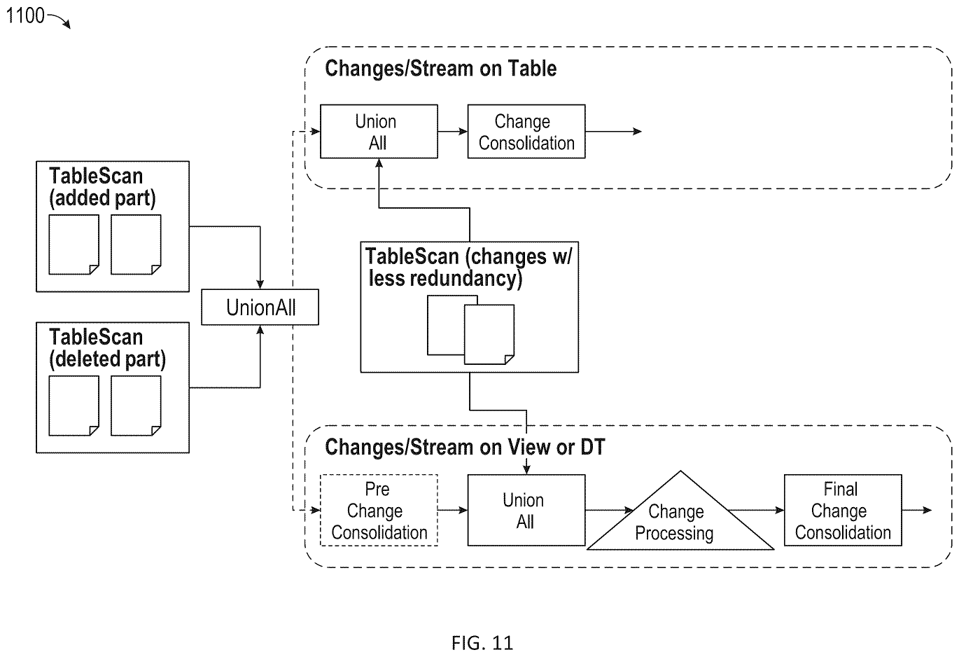

FIG. 11 is an example 1100 of PLGs with few redundant changes, in accordance with some embodiments of the present disclosure.

Changes with little redundancy remain valuable in the change computation process, despite requiring consolidation:
1. For streams/changes on views and Dynamic Tables (DTs):
   These changes can bypass the change pre-consolidation step, making this phase more lightweight.
   This optimization still provides benefits through a reduced number of changes during:
      a) The change processing step
      b) The final consolidation step
2. For streams/changes on tables:
   The input to the final change consolidation becomes smaller due to the reduced number of redundant changes.
   This reduction in input size can potentially improve the overall performance of the change computation process.

These optimizations contribute to the overall goal of the faster change computation method, which aims to significantly reduce the number of input rows for change processing and consolidation steps.

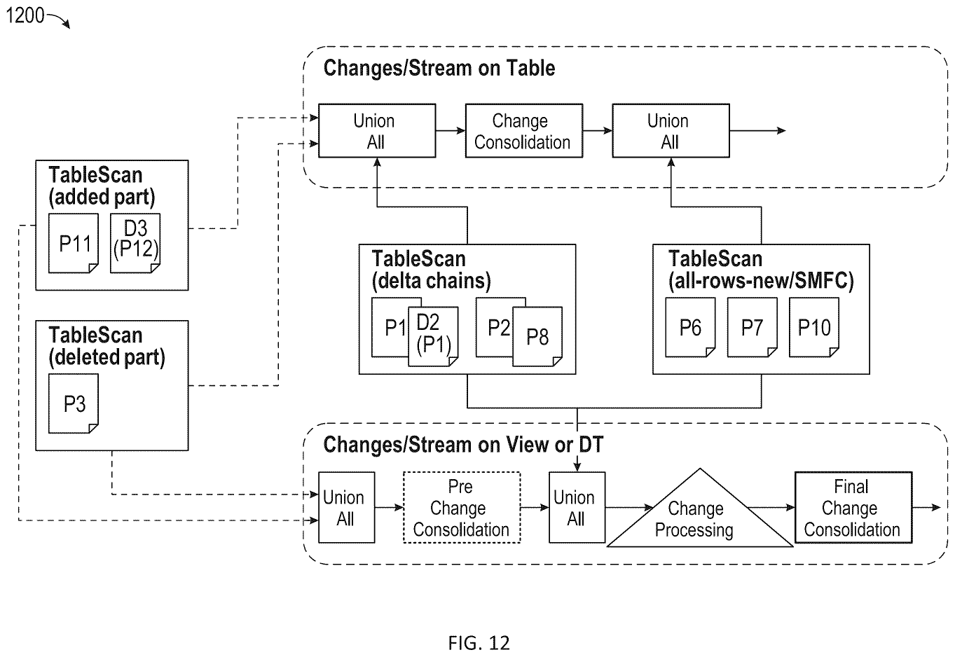

FIG. 12 is an example 1200 of change computation with a set of optimizations, in accordance with some embodiments of the present disclosure.

The optimization approaches for faster change computation in the example of FIG. 12 include the following:
1. All-new partitions (PLGs 3, 4, and part of 5):
   Partitions P6 and P7 contain only new rows, while P10 contains both new rows and rows copied forward from P4 due to Small-File Garbage Collection (SFGC). The copied rows in P10 can be easily filtered out using the MD$OPN=NULL predicate. The changes produced from these partitions are “pure” without redundancies.
   For streams/changes on tables, these pure changes can be directly included in the output. For streams/changes on views or Dynamic Tables (DTs), these changes can bypass the change pre-consolidation step and be fed directly into the change processing step.
2. Delta lineage chain (PLG 1):
   Changes from the root-file/delta-file pair P1/D2 are extracted using the delta lineage chain approach, which leverages the cumulative nature of delta files to efficiently compute changes.
3. Copy-on-Write (CoW) changes with bitset tracking (PLG 2a):
   Change extraction for the partition pair P2/P8 utilizes COW bitset tracking and the MD$WC (METADATA$WAS_COPIED) column. Since P2 is in the set of unregistered partitions and P8 is in the set of registered partitions, only one CoW operation was applied, allowing for efficient change extraction.
   The changes extracted from PLG 1 and PLG 2a, while not pure, still offer benefits. They are passed into change consolidation (for streams/changes on tables) or change pre-consolidation (for streams/changes on views or DTs). This approach is advantageous because it significantly reduces the number of extracted changes compared to full scans of all four partitions.
4. Complex partition lineage (PLG 2b):

For the more complex PLG 2b, which connects partitions P2, P11, and D3 (P12), a sophisticated change extraction mechanism is not available due to its complexity. In this case, changes are extracted using full partition scans, and all rows are passed into change consolidation.

The combination of these approaches results in a substantial reduction in the number of partitions requiring full change consolidation, decreasing from 11 to 3 in the given example. This optimization significantly improves the efficiency of the change computation process by reducing the volume of data that needs to be processed during the consolidation steps.

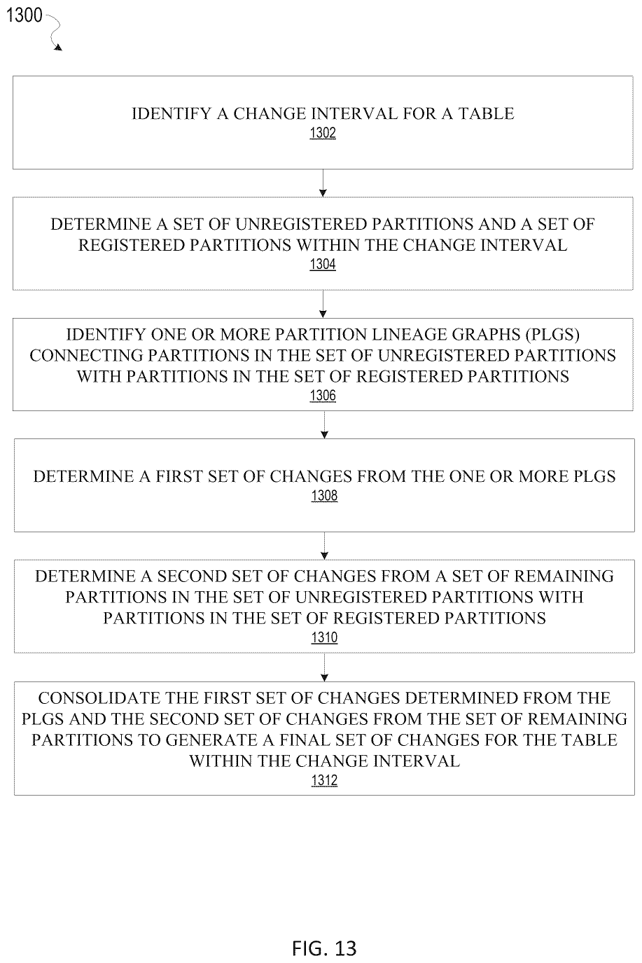

FIG. 13 is a flow diagram illustrating operations of a database system in performing a method 1300, in accordance with some embodiments of the present disclosure. The method 1300 may be embodied in computer-readable instructions for execution by one or more hardware components (e.g., one or more processors) such that the operations of the method 1300 may be performed by components of data platform 102. Accordingly, the method 1300 is described below, by way of example with reference thereto. However, it shall be appreciated that method 1300 may be deployed on various other hardware configurations and is not intended to be limited to deployment within the data platform 102.

At operation 1302, DML engine 109 identifies a change interval for a table, the change interval having a start time and an end time.

At operation 1304, DML engine 109 determines a set of unregistered partitions and a set of registered partitions within the change interval.

At operation 1306, DML engine 109 identifies one or more partition lineage graphs (PLGs) connecting partitions in the set of unregistered partitions with partitions in the set of registered partitions.

At operation 1308, DML engine 109 determines a first set of changes from the one or more PLGs.

At operation 1310, DML engine 109 determines a second set of changes from a set of remaining partitions in the set of unregistered partitions with partitions in the set of registered partitions.

At operation 1312, DML engine 109 consolidates the first set of changes determined from the one or more PLGs and the second set of changes from the set of remaining partitions to generate a final set of changes for the table within the change interval.

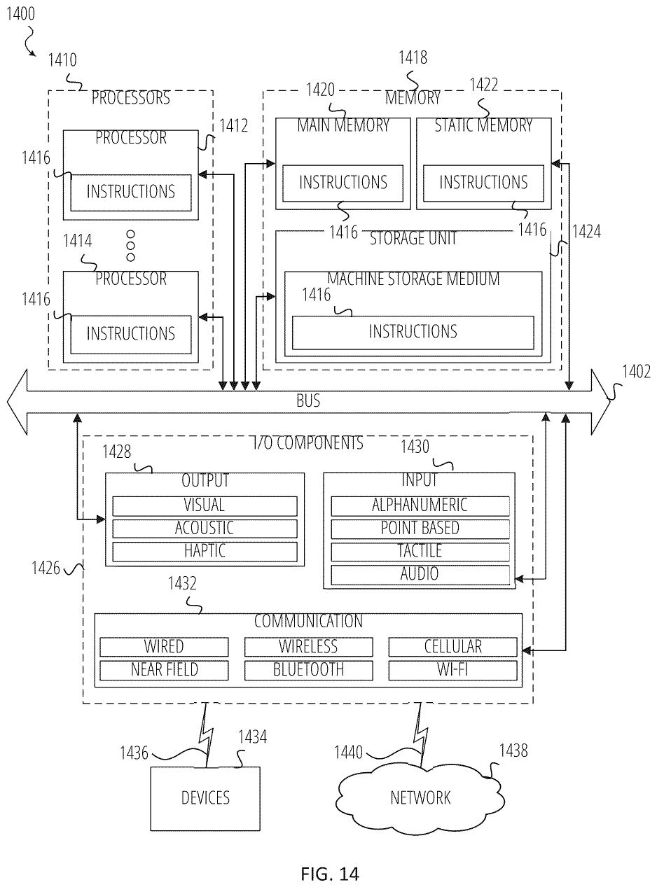

FIG. 14 illustrates a diagrammatic representation of a machine 1400 in the form of a computer system within which a set of instructions may be executed for causing the machine 1400 to perform any one or more of the methodologies discussed herein, according to an example embodiment. Specifically, FIG. 14 shows a diagrammatic representation of the 1400 in the example form of a computer system, within which instructions 1416 (e.g., a software, a program, an application, an applet, an app, or other executable code) for causing the machine 1400 to perform any one or more of the methodologies discussed herein may be executed. For example, the instructions 1416 may cause the machine 1400 to execute any one or more operations of the method(s) described before. As another example, the instructions 1416 may cause the machine 1400 to implement any one or more portions of the functionality illustrated in any one of at least some of the figures described herein. In this way, the instructions 1416 transform a general, non-programmed machine into a particular machine that is specially configured to carry out any one of the described and illustrated functions of the data platform 102 such as the compute service manager 108 (or a component thereof such as the DML engine 109) or an execution node of the execution platform 110.

In some embodiments, the machine 1400 operates as a standalone device or may be coupled (e.g., networked) to other machines. In a networked deployment, machine 1400 may operate in the capacity of a server machine or a client machine in a server-client network environment or as a peer machine in a peer-to-peer (or distributed) network environment. The machine 1400 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1416, sequentially or otherwise, that specify actions to be taken by the machine 1400. Further, while only a single machine 1400 is illustrated, the term “machine” shall also be taken to include a collection of machines 1400 that individually or jointly execute the instructions 1416 to perform any one or more of the methodologies discussed herein.

The machine 1400 includes processors 1410, memory 1418, and i/o components 1426 configured to communicate with each other such as via a bus 1402. In an example embodiment, the processors 1410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1412 and a processor 1414 that may execute the instructions 1416. The term “processor” is intended to include multi-core processors 1410 that may comprise two or more independent processors (sometimes referred to as “cores”) that may execute instructions 1416 contemporaneously. Although FIG. 14 shows multiple processors 1410, the machine 1400 may include a single processor with a single core, a single processor with multiple cores (e.g., a multi-core processor), multiple processors with a single core, multiple processors with multiple cores, or any combination thereof.

The memory 1418 may include a main memory 1420, a static memory 1422, and a storage unit 1424, all accessible to the processors 1410 such as via the bus 1402. The main memory 1420, the static memory 1422, and the storage unit 1424 store the instructions 1416 embodying any one or more of the methodologies or functions described herein. The instructions 1416 may also reside, completely or partially, within the main memory 1420, within the static memory 1422, within the storage unit 1424, within at least one of the processors 1410 (e.g., within the processor's cache memory), or any suitable combination thereof, during execution thereof by the machine 1400.

The i/o components 1426 include components to receive input, provide output, produce output, transmit information, exchange information, capture measurements, and so on. The specific i/o components 1426 that are included in a particular machine 1400 will depend on the type of machine. For example, portable machines such as mobile phones will likely include a touch input device or other such input mechanisms, while a headless server machine will likely not include such a touch input device. It will be appreciated that the i/o components 1426 may include many other components that are not shown in FIG. 14. The i/o components 1426 are grouped according to functionality merely for simplifying the following discussion and the grouping is in no way limiting. In various example embodiments, the i/o components 1426 may include output components 1428 and input components 1430. The output components 1428 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1430 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The i/o components 1426 may include communication components 1432 operable to couple the machine 1400 to a network 1438 or devices 1434 via a coupling 1440 and a coupling 1436, respectively. For example, the communication components 1432 may include a network interface component or another suitable device to interface with the network 1438. In further examples, the communication components 1432 may include wired communication components, wireless communication components, cellular communication components, and other communication components to provide communication via other modalities. The devices 1434 may be another machine or any of a wide variety of peripheral devices (e.g., a peripheral device coupled via a universal serial bus (USB)). For example, as noted above, the machine 1400 may correspond to any one of the compute service manager 108, the execution platform 110, and the devices 1434 may include the data store 206 or any other computing device described herein as being in communication with the data platform 102 or the data storage 104.

The various memories (e.g., memory 1418, main memory 1420, static memory 1422, and/or memory of the processor(s) processors 1410 and/or the storage unit 1424) may store one or more sets of instructions 1416 and data structures (e.g., software) embodying or utilized by any one or more of the methodologies or functions described herein. These instructions 1416, when executed by the processor(s) processors 1410, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 1438 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1438 or a portion of the network 1438 may include a wireless or cellular network, and the coupling 1440 may be a Code Division Multiple Access (CDMA) connection, a Global System for Mobile communications (GSM) connection, or another type of cellular or wireless coupling. In this example, the coupling 1440 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1416 may be transmitted or received over the network 1438 using a transmission medium via a network interface device (e.g., a network interface component included in the communication components 1432) and utilizing any one of a number of well-known transfer protocols (e.g., hypertext transfer protocol (HTTP)). Similarly, the instructions 1416 may be transmitted or received using a transmission medium via the coupling 1436 (e.g., a peer-to-peer coupling) to the devices 1434. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1416 for execution by the machine 1400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory, the at least one memory storing instructions that cause the at least one hardware processor to perform operations comprising:
identifying a change interval for a table, the change interval having a start time and an end time;
determining a set of unregistered partitions and a set of registered partitions within the change interval;
identifying one or more partition lineage graphs (PLGs) connecting partitions in the set of unregistered partitions with partitions in the set of registered partitions;
determining a first set of changes from the one or more PLGs;
determining a second set of changes from a set of remaining partitions in the set of unregistered partitions with partitions in the set of registered partitions; and
consolidating the first set of changes determined from the one or more PLGs and the second set of changes from the set of remaining partitions to generate a final set of changes for the table within the change interval.

2. The system of claim 1, wherein the operations further comprise:
extracting the set of changes from the one or more PLGs without producing redundant change rows; and
removing one or more partitions associated with the PLG from the set of registered partitions and the set of unregistered partitions.

3. The system of claim 1, wherein the operations further comprise:
scanning one or more registered partitions from the set of remaining partitions to emit rows as inserted; and
scanning one or more unregistered partitions from the set of remaining partitions to emit rows as deleted.

4. The system of claim 1, wherein the operations further comprise:
identifying a first particular set of PLGs with pure changes, the pure changes comprising changes that do not require consolidation and the changes being extracted without any redundancies; and
identifying a second particular set of PLGs with a set of redundant changes lower than a threshold amount of changes.

5. The system of claim 1, wherein the operations further comprise:
for a particular PLG with only new partitions, identifying a set of particular partitions that include only new rows based on metadata indicating the only new rows being included in the set of particular partitions; and
emitting each row from the set of particular partitions as inserted without going through change consolidation.

6. The system of claim 1, wherein the operations further comprise:
identifying a set of fully deleted partitions in the set of unregistered partitions; and
extracting a particular set of changes from the set of fully deleted partitions by emitting each row as deleted without going through change consolidation.

7. The system of claim 1, wherein the operations further comprise:
identifying a set of delta file lineage chains by searching for one or more partitions with at least one common root partition in the set of unregistered partitions and the set of registered partitions, wherein the identifying is based on metadata comprising root partition relationship information.

8. The system of claim 7, wherein the operations further comprise:
for an unregistered root partition and a registered combined partition:
scanning a particular root file,
filtering the particular root file by a bitset in a final delta file, and
emitting a set of remaining rows as deleted; and
scanning the final delta file and emitting a set of rows from the final delta file as inserted.

9. The system of claim 4, wherein the operations further comprise:
applying change pre-consolidation to changes extracted from the one or more PLGs with the set of redundant changes lower than the threshold amount of changes; and
bypassing change pre-consolidation for changes extracted from the one or more PLGs with the pure changes.

10. The system of claim 1, wherein the operations further comprise:
for a Copy-on-Write (CoW) partition, generating and storing a bitset that tracks which rows were deleted or updated; and
extracting a set of changes from the CoW partition.

11. A method comprising:
identifying a change interval for a table, the change interval having a start time and an end time;
determining a set of unregistered partitions and a set of registered partitions within the change interval;
identifying one or more partition lineage graphs (PLGs) connecting partitions in the set of unregistered partitions with partitions in the set of registered partitions;
determining a first set of changes from the one or more PLGs;
determining a second set of changes from a set of remaining partitions in the set of unregistered partitions with partitions in the set of registered partitions; and
consolidating the first set of changes determined from the one or more PLGs and the second set of changes from the set of remaining partitions to generate a final set of changes for the table within the change interval.

12. The method of claim 11, further comprising:
extracting the set of changes from the one or more PLGs without producing redundant change rows; and
removing one or more partitions associated with the PLG from the set of registered partitions and the set of unregistered partitions.

13. The method of claim 11, further comprising:
scanning one or more registered partitions from the set of remaining partitions to emit rows as inserted; and
scanning one or more unregistered partitions from the set of remaining partitions to emit rows as deleted.

14. The method of claim 11, further comprising:
identifying a first particular set of PLGs with pure changes, the pure changes comprising changes that do not require consolidation and the changes being extracted without any redundancies; and
identifying a second particular set of PLGs with a set of redundant changes lower than a threshold amount of changes.

15. The method of claim 11, further comprising:
for a particular PLG with only new partitions, identifying a set of particular partitions that include only new rows based on metadata indicating the only new rows being included in the set of particular partitions; and
emitting each row from the set of particular partitions as inserted without going through change consolidation.

16. The method of claim 11, further comprising:
identifying a set of fully deleted partitions in the set of unregistered partitions; and
extracting a particular set of changes from the set of fully deleted partitions by emitting each row as deleted without going through change consolidation.

17. The method of claim 11, further comprising:
identifying a set of delta file lineage chains by searching for one or more partitions with at least one common root partition in the set of unregistered partitions and the set of registered partitions, wherein the identifying is based on metadata comprising root partition relationship information.

18. The method of claim 17, further comprising:
for an unregistered root partition and a registered combined partition:
scanning a particular root file,
filtering the particular root file by a bitset in a final delta file, and
emitting a set of remaining rows as deleted; and
scanning the final delta file and emitting a set of rows from the final delta file as inserted.

19. The method of claim 14, further comprising:
applying change pre-consolidation to changes extracted from the one or more PLGs with the set of redundant changes lower than the threshold amount of changes; and
bypassing change pre-consolidation for changes extracted from the one or more PLGs with the pure changes.

20. A non-transitory computer-storage medium comprising instructions that, when executed by one or more processors of a machine, configure the machine to perform operations comprising:
identifying a change interval for a table, the change interval having a start time and an end time;
determining a set of unregistered partitions and a set of registered partitions within the change interval;
identifying one or more partition lineage graphs (PLGs) connecting partitions in the set of unregistered partitions with partitions in the set of registered partitions;
determining a first set of changes from the one or more PLGs;
determining a second set of changes from a set of remaining partitions in the set of unregistered partitions with partitions in the set of registered partitions; and
consolidating the first set of changes determined from the one or more PLGs and the second set of changes from the set of remaining partitions to generate a final set of changes for the table within the change interval.
